(19) United States
(12) Patent Application Publication
(10) Pub. No.: US 2006/0227491 A1
(43) Pub. Date: Oct. 12, 2006

(54) Hair blower with positive and negative ion emitters

(75) Inventors: Dan Rosati, Verona, WI (US); John H. Wilcox, Newport, RI (US); Gary Lee McMurray, Verona, WI (US); Amy E. Wimmer, Madison, WI (US)

Correspondence Address: SENNIGER POWERS, ONE METROPOLITAN SQUARE, 16TH FLOOR, ST LOUIS, MO, 63102, US

(73) Assignee: Rovcal, Inc., Madison, WI (US)

(21) Appl. No.: 11/102,285

(22) Filed: Apr. 7, 2005

(51) Int. Cl. H01H 1/00

(52) U.S. Cl. 361/229

(57) ABSTRACT

A hair blower has an interior space, an air inlet, an air outlet and a fan assembly for directing air to flow from the air inlet to the air outlet. A positive ion emitter is operable to emit positive ions in the interior space for entrainment in the air upstream of the air outlet. A negative ion emitter in the interior space of the housing is separate from the positive ion emitter and is operable to emit negative ions for entrainment in the air upstream of the air outlet. A switch assembly allows selective operation of the hair blower between a negative ion mode in which the negative ion emitter is operated to emit negative ions and the positive ion emitter is inoperable, and a positive ion mode in which the positive ion emitter is operated to emit positive ions and the negative ion emitter is inoperable.

### FIELD OF INVENTION

This invention relates generally to hair blowers such as those use for drying and/or styling hair, and more particularly to electrically powered hair blowers that emit an outflow of ions toward the hair during operation of the hair dryer.

### BACKGROUND

Hair blowers, such as hair dryers, air stylers and the like, are commonly used for drying and/or styling hair, and in particular human or animal hair. Conventional hair dryers and air stylers are generally hand-held devices having a housing in which an electric fan and suitable electric heating element are disposed. Upon operation, the fan draws air into the housing for heating by the heating element. Heated air is blown out of the housing and directed toward the wet hair for drying. It has also been found desirable to entrain negative ions in the heated air flow exiting the dryer or styler so that the hair becomes subjected to the negative ions. Where the hair is wet, instead of boiling the water molecules on the wet hair to evaporate the water as in conventional hair dryers, the negative ions break down the water molecules on the wet hair into micro-sized particles. Some of the reduced sized particles penetrate the hair shaft to replenish the hair while the rest are more readily evaporated, thereby providing a shorter drying time while reducing heat damage to the hair.

It is believed that providing negative ions in the air flow also diminishes static charge and flyaway of the hair by neutralizing positive ions, leaving a smoother, silkier appearance to the hair. One example of a hair dryer that emits negative ions during use is available from Rayovac Corporation of Madison, Wis. under the trade designation Remington® Pro Air® Ionic Dryer. While large amounts of positive ions sometimes carry a negative connotation, small amounts of positive ions may neutralize hair's natural negative charge and smooth and tighten the hair shaft's outer cuticle layer to render hair more manageable and softer feeling.

To this end, U.S. Pat. No. 6,640,049 discloses a hair dryer having a heating coil that, upon heating, thermionically emits a surplus of positive ions and, where the heating coil is coated with, e.g., ceramic, negative ions. Rectifier circuitry imposes an electrical charge of chosen polarity upon a conductive grid in the flow path of air flow exiting the hair dryer. In particular, positive and negative ion generation is functionally dependent upon the heating coil temperature. For example, the heating coil must be at least 600 degrees Celsius to produce even a small number of negative ions along with the positive ions, and at least 750 degrees Celsius to produce a substantially increased number of negative ions along with the positive ions. When the conductive grid is positively charged, it attracts negative ions emitted by the heating element and repels positive ions, resulting in a net surplus of negative ions in the hot air flow exiting the dryer. The circuitry of the dryer allows switching the polarity of the grid between positive and negative charges depending on whether negative ions or positive ions are desired in the heated air flow.

Because the ion generation of such a hair dryer is functionally tied to the heating coil temperature, the ion production, and in particular the negative ion production, can only be achieved at high heating coil temperatures. This limits the useability of the positive and negative ion features of the hair dryer at lower heat settings and reduces the efficiency of the hair dryer. There is a need, therefore, for a hair blower that selectively emits positive and negative ions at lower heating element temperatures or is otherwise operable to emit positive and negative ions independent of the heating element temperature. There is also a need for a hair dryer having separate positive and negative ion emitters capable of selective, independent operation.

### SUMMARY

In general, a hair blower according to one embodiment comprises a housing having an interior space, an air inlet through which air enters the interior space and an air outlet through which air is exhausted from the interior space. A fan assembly is disposed in the interior space intermediate the air inlet and air outlet and is operable to draw air into the interior space of the housing at the air inlet and to direct the air to flow through said interior space for exhaustion from the housing at the air outlet. A positive ion emitter in the interior space of the housing is operable to emit positive ions for entrainment in the air prior to exhaustion of the air from the housing. A negative ion emitter in the interior space of the housing is separate from the positive ion emitter and is operable to emit negative ions for entrainment in the air prior to exhaustion of the air from the housing. A switch assembly allows selectively operating the hair blower between a negative ion mode in which the negative ion emitter is operated to emit negative ions and the positive ion emitter is inoperable, and a positive ion mode in which the positive ion emitter is operated to emit positive ions and the negative ion emitter is inoperable.

In another embodiment, the hair blower generally comprises a housing having an interior space, an air inlet through which air enters the interior space and an air outlet through which air is exhausted from the interior space. A fan assembly is disposed in the interior space intermediate the air inlet and air outlet and is operable to draw air into the interior space of the housing at the air inlet and to direct the air to flow through the interior space for exhaustion from the housing at the air outlet. A heating element in the interior space intermediate the air inlet and air outlet is operable during operation of the hair dryer to heat air within the interior space of the housing prior to the air being exhausted from the housing at the air outlet. The heating element has a heating element temperature during operation of the hair blower. A positive ion emitter in the interior space of the housing is operable to emit positive ions for entrainment in the air prior to exhaustion of the air from the housing, with operation of the positive ion emitter to emit positive ions being independent of the heating element temperature. A negative ion emitter in the interior space of the housing is separate from the positive ion emitter and operable to emit negative ions for entrainment in the air prior to exhaustion of the air from the housing, with operation of the negative ion emitter to emit negative ions being independent of the heating element temperature. An ion switch assembly allows for selectively operating the hair blower between a negative ion mode in which the negative ion emitter is operated to emit negative ions and the positive ion emitter is inoperable, and a positive ion mode in which the positive ion emitter is operated to emit positive ions and the negative ion emitter is inoperable.

In yet another embodiment, the hair blower generally comprises a housing having an interior space, an air inlet through which air enters the interior space and an air outlet through which air is exhausted from the interior space. A fan assembly is disposed in the interior space intermediate the air inlet and air outlet and is operable to draw air into the interior space of the housing at the air inlet and to direct the air to flow through said interior space for exhaustion from the housing at the air outlet. A heating element in the interior space intermediate the air inlet and air outlet is operable during operation of the hair blower to heat air within the interior space of the housing prior to the air being exhausted from the housing at the air outlet. The hair blower is operable in a negative ion mode in which negative ions are emitted within the interior space of the housing for entrainment in the air prior to the air exiting from the housing at the air outlet and a positive ion mode in which positive ions are emitted within the interior space of the housing for entrainment in the air prior to the air exiting from the housing at the air outlet. The hair dryer further comprises a switch assembly for selectively operating the hair blower between its negative ion mode and its positive ion mode. First indicia is disposed on the housing and associated with the switch assembly, and is indicative of a suggested use of the hair blower in the negative ion mode of operation. Second indicia is disposed on the housing and associated with the switch assembly, and is indicative of a suggested use of the hair blower in the positive ion mode of operation different from the suggested use of the hair dryer in the negative ion mode of operation.

In one embodiment of a process for blowing hair using a hair blower capable of generating an air flow within the hair blower for subsequent exhaustion therefrom for flow over the hair, negative ions are entrained in the air flow prior to the air flow being exhausted from the hair blower. The negative ion air flow is directed toward the hair while the hair is wet until the hair is substantially dried. Positive ions are subsequently entrained in the air flow prior to the air flow being exhausted from the hair blower once the hair is substantially dried. The positive ion air flow is then directed toward the hair once the hair is substantially dried.

### BRIEF DESCRIPTION OF THE DRAWINGS

FIG. 1 is a side elevation of one embodiment of a hair blower of the present invention in the form of a hair dryer;

FIG. 2 is a front elevation of the hair dryer of FIG. 1;

FIG. 3 is a rear elevation of the hair dryer of FIG. 1;

FIG. 4 is a side elevation of the hair dryer of FIG. 1 with a portion removed to show internal construction;

FIG. 5 is a vertical cross-section of the hair dryer of FIG. 1;

FIG. 6 is a horizontal cross-section taken through a barrel portion of the hair dryer of FIG. 1; and

FIG. 7 is a schematic wire diagram of the electrical circuit of the hair dryer of FIG. 1.

Corresponding reference characters indicate corresponding parts throughout the drawings.

### DETAILED DESCRIPTION

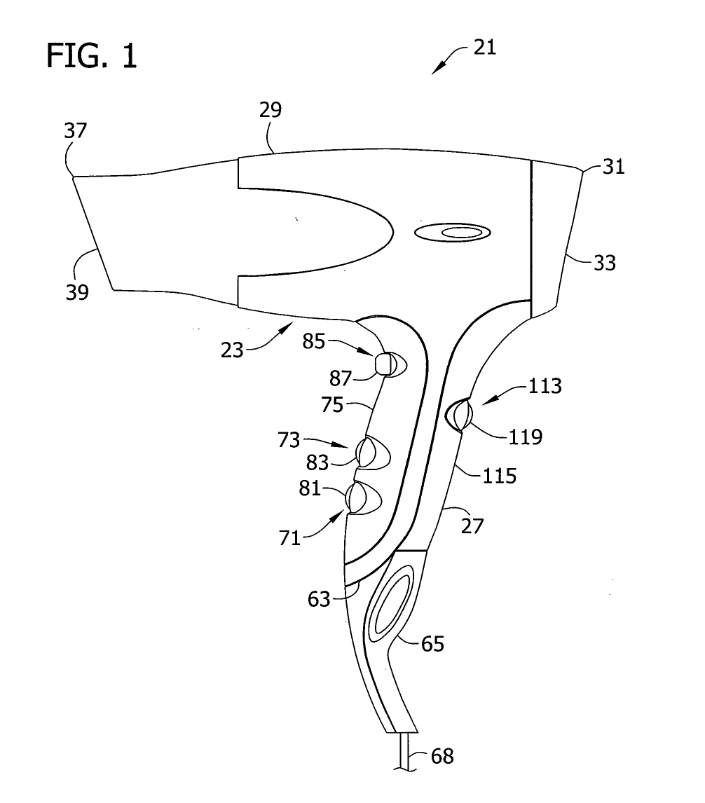

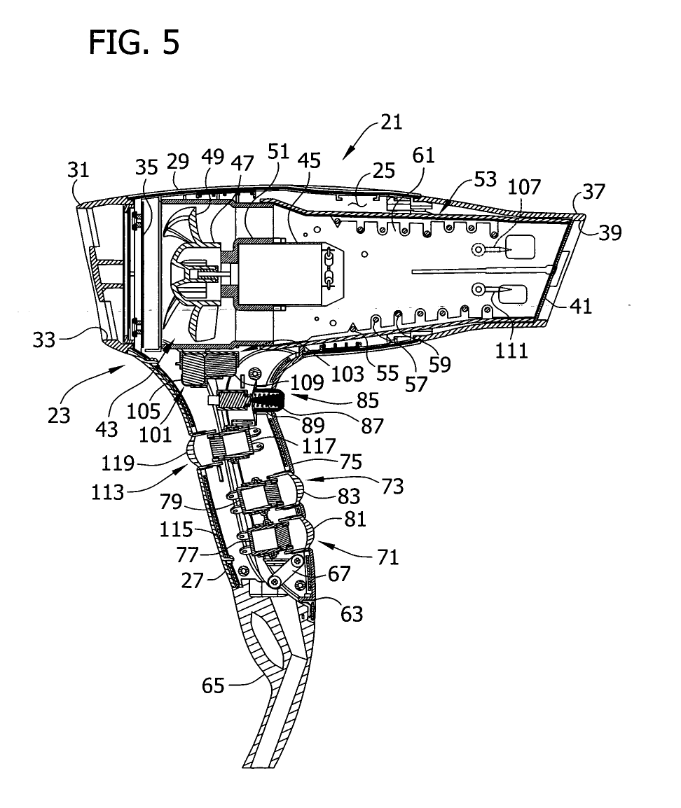

Referring now to the drawings, and in particular to FIGS. 1 and 5, a hair blower according to one embodiment of the present invention is illustrated in the form of a hair dryer and is indicated generally at 21. It is understood, however, that the various concepts of the present invention may be incorporated in other hair blowers, such as an air styler, without departing from the scope of this invention. The hair dryer 21 of the illustrated embodiment comprises a housing, generally indicated at 23, having an interior space 25 (FIG. 5) in which the various components of the dryer are disposed. The illustrated hair dryer 21 is a hand-held dryer and particularly comprises a handle 27 configured for manually gripping and holding the hair dryer, and a barrel 29 mounted on the handle and extending generally normal to the handle for housing operating components of the dryer. The handle 27 and barrel 29 are each generally hollow and together define the interior space 25 of the housing 23. The barrel 29 of the housing 23 has an upstream or inlet end 31 including an air inlet 33 through which air enters the interior space 25 of the housing, and a metal inlet grill 35 (FIG. 5), such as a steel grill, disposed generally within the air inlet 33. A downstream or outlet end 37 of the barrel 29 includes an air outlet 39 through which air is exhausted from the barrel, and a metal outlet grill 41, such as a steel grill, spanning the air outlet.

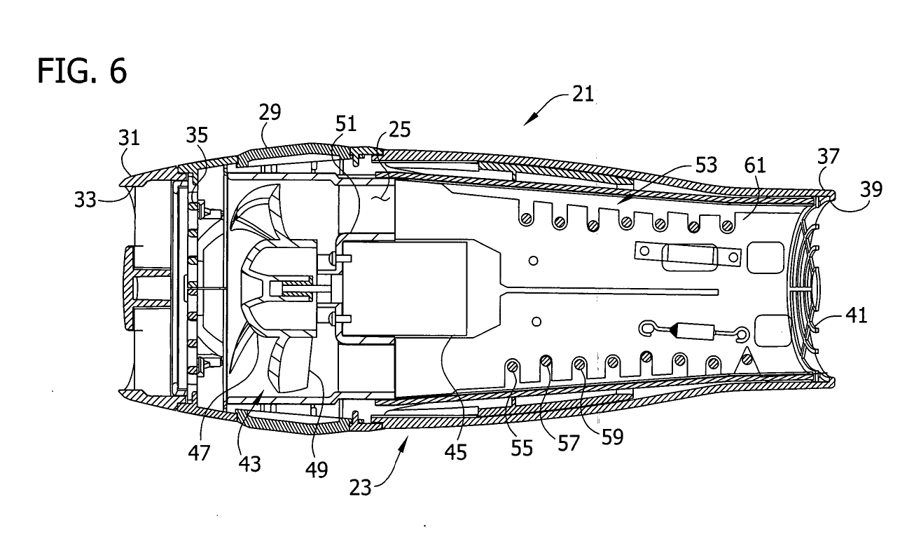

A fan assembly, generally indicated at 43 and best illustrated in FIGS. 5 and 6, is disposed within the interior space 25 of the housing 23, and more suitably in the barrel 29 intermediate the air inlet 33 and air outlet 39, to draw air into the barrel at the air inlet and direct an air flow through the barrel to the air outlet. In the illustrated embodiment the fan assembly 43 comprises an electric motor 45 and a fan 47 having suitable fan blades 49 and being drivingly connected to the motor. The motor 45 is mounted in the barrel 29 by a suitable mount 51 disposed generally above the handle 27 near the inlet end 31 of the barrel, with the fan 47 being located upstream of the motor for disposition generally adjacent the air inlet of the barrel.

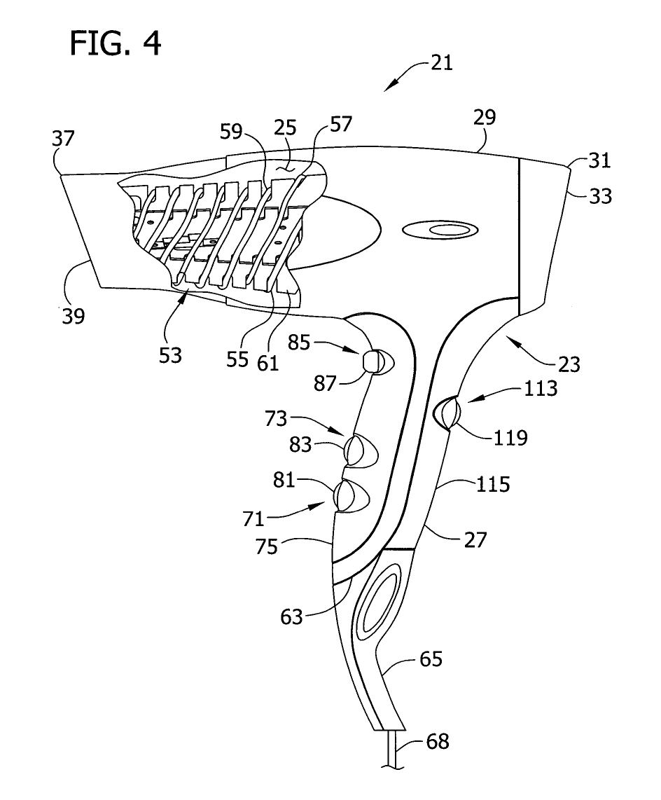

With particular reference to FIGS. 4-6, a heating element, generally indicated at 53, is also housed within the barrel 29 along the air flow path between the air inlet 33 and the air outlet 39, and more suitably between the fan assembly 43 and the air outlet, for heating air flowing within the barrel before the air exits the air outlet. The heating element 53 may suitably comprise one or more electrically conductive wires wound around a suitable support board 61, such as a multi-board unit (e.g., having a hub and multiple spokes cross-section) constructed of mica. As one example, the heating element 53 of FIGS. 4-6 comprises three different conductive wires 55, 57, 59 wrapped about the support board in intersticed relationship with each other so that each wire extends longitudinally substantially the length of the support board. Each conductive wire 55, 57, 59 has a different impedance (e.g., about 42 ohms, about 23 ohms and about 17.5 ohms, respectively) to permit different levels of heat to be generated by the heating element as described later herein. It is understood, however, that more or less than three wires 55, 57, 59, including a single wire, may be used without departing from the scope of this invention.

In one embodiment, the heating element 53 may have a temperature during activation thereof of less than or equal to about 525 degrees Celsius, and more suitably in the range of about 200 degrees Celsius to about 525 degrees Celsius. Where the heating element 53 comprises more than one conductive wire 55, 57, 59, such as in the illustrated embodiment, the heating element temperature as used herein refers to the temperature of the hottest active wire. For example, the different impedance and construction of the wires 55, 57, 59 results in the wires having different temperatures when all of them (or at least two of them) are active (i.e., when current is conducted therethrough). Moreover, as described in further detail later herein, not all of the wires 55, 57, 59 are active at the same time. Accordingly, where a wire capable of having the hottest temperature is inactive, the temperature of the heating element will be lower than when that wire is active. It is understood that the temperature of the heating element 53 is also somewhat dependent on the fan 47 speed (i.e., the volume of air flow past the heating element). It is contemplated, therefore, that the heating element 53 temperature during operation of the hair dryer may suitably be less than or equal to about 400 degrees, or even less than or equal to about 300 degrees. It is also understood that the heating element 53 may be inactive during operation of the hair dryer, i.e., all of the wires 55, 57, 59 may be inactive, without departing from the scope of this invention.

It is also contemplated that the heating element 53 may alternatively be disposed upstream of the fan assembly 43 without departing from the scope of this invention. Operation and construction of the fan assembly 43 and heating element 53 to produce a flow of heated air exhausted from the barrel 29 at the air outlet 39 is otherwise known to those skilled in the art and will not be described further herein except to the extent necessary to disclose the present invention. It is further understood that a fan assembly 43 and/or heating element 53 constructed other than as shown in the illustrated embodiment and described above may be used in the hair dryer 21 without departing from the scope of this invention.

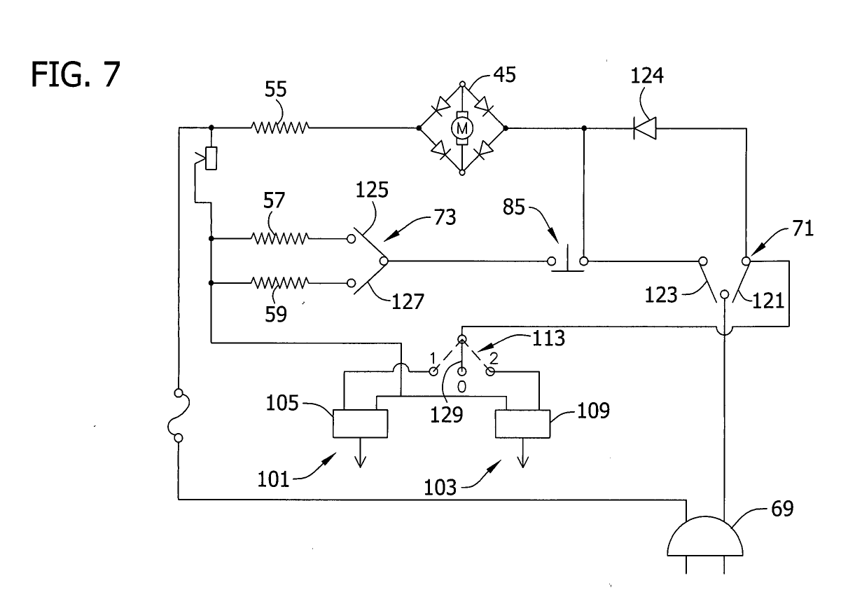

Referring back to FIGS. 1 and 5, the handle 27 of the housing 21 has a terminal end 63 to which a boot 65, or bushing is connected and extends outward for receiving an electrical power cord 68 (FIG. 1) into the terminal end of the handle. The power cord 68 is clamped to the terminal end 63 of the dryer 21 by a suitable cord clamp 67 and when connected to an external source 69 (shown schematically in FIG. 7) of electrical current delivers current into the dryer for operating its various components. Alternatively, the source 69 of electrical current may comprise a suitable battery (not shown) housed with the handle 27 or otherwise the interior space 25 of the dryer 21 and remain within the scope of this invention. A pair of switch assemblies, generally indicated at 71 and 73, are located on what is referred to herein as a front side 75 of the handle 27 (which corresponds generally to where the user's fingers would be positioned upon gripping the handle). Each switch assembly 71, 73 comprises a respective switch 77, 79 disposed within the handle 27 and a corresponding switch cover 81, 83 operatively connected to the switch and extending outward of the handle for accessibility in manually operating the switch.

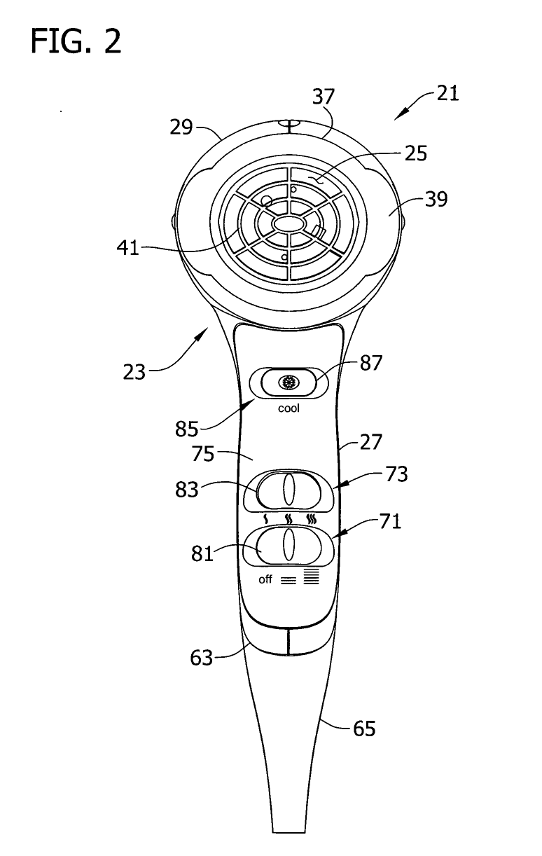

In particular, as best illustrated in FIG. 2, one switch assembly is a fan switch assembly 71 that also operates as the overall on/off switch assembly for the hair dryer 21. That is, the switch assembly 71 is operable to switch the dryer 21 between an off mode in which the entire dryer is inoperable, a low speed mode in which the fan assembly 43 is operated at a relatively low speed and a high speed mode in which the fan assembly is operated at a high speed. It is understood, however, that the switch assembly 71 may have more than two fan speed settings, or only one fan speed setting, without departing from the scope of this invention. The other switch assembly is a heat switch assembly 73 that controls the temperature of the heating element 53. The heat switch assembly 73 of the illustrated embodiment is operable to switch the heating element 53 temperature between a low heat mode, a medium heat mode and a high heat mode. However, it is contemplated that more or less than three heat settings may be provided and remain within the scope of this invention. It is also understood that the heat switch assembly 73 may have an off mode in which the heating element 53 is inactive and thus does not generate any heat during operation of the fan assembly 43.

Further up the handle 27 toward the barrel 29 is a button-type switch assembly, generally indicated at 85, used to selectively deliver relatively cooler air from the air outlet 39 of the barrel 29. As shown in FIG. 5, the cool air switch assembly 85 includes a button 87 extending outward from the front 75 of the handle 27 and spring biased by a suitable spring 89 to a relaxed position. The button 87 may be depressed inward relative to the handle 27 against the bias of the spring 89 to a depressed position in which current flow to at least one, and in the illustrated embodiment two, of the conductive wires 55, 57, 59 of the heating element is interrupted, resulting in cooler air being exhausted from the air outlet until the button is released. It is contemplated that depression of the button 87 may even interrupt current flow to all of the conductive wires 55, 57, 59 to render the heating element 53 inactive until the button is released.

With particular reference now to FIG. 5, the hair dryer 21 further comprises a positive ion emitter, generally indicated at 101, for emitting positive ions into the air flow within the barrel 29 before the air is exhausted from the air outlet 39, and a negative ion emitter, generally indicated at 103, for emitting negative ions into the air flow prior to exhaustion from the air outlet. The positive ion emitter 101 of the illustrated embodiment is disposed entirely within the interior space 25 of the housing 23 and comprises a positive ion generator 105 and a corresponding emitting member 107 electrically connected to the positive ion generator by suitable wiring (not shown).

In one embodiment, the positive ion generator 105 is suitably a high voltage generator disposed in the interior space 25 of the housing 23 generally within the handle 27, and more particularly toward the top of the handle adjacent the barrel 29. The ion generator 105 is suitably configured for receiving current from the current source, such as about 125 volts, and generating a positive high voltage, such as in the range of about 4 kV to about 10 kV, and more suitably in the range of about 7 kV to about 9 kV. As an example, one suitable ion generator for use as the positive ion generator 105 is available from Seawise Industrial Ltd. of Kowloon Hong Kong as model designation SW750H-9-3. Another suitable ion generator is available from Fu Fong Enterprises Co., Chung-Li City, Taiwan, Republic of China.

The positive ion emitting member 107 of the illustrated embodiment is suitably needle-shaped and is constructed of an electrically conductive metal, such as steel or other suitable metal. The emitting member 107 serves as an electrode for receiving the positive high voltage generated by the ion generator 105, thereby releasing positive ions into the interior space 25 of the housing 23, and more particularly within the barrel 29. More suitably, the positive ions are released into the flow path of air flowing within the barrel 29 toward the air outlet 39 so that the positive ions become entrained in the air flow exhausted from the air outlet. It is contemplated that more than one positive ion emitting member 107 may be used without departing from the scope of this invention.

In one embodiment, the air flow exiting the air outlet 39 during operation of the hair dryer 21 to emit positive ions has a positive ion density of at least about 0.5 million positive ions per cubic centimeter of air flow, more suitably at least about 1 million positive ions per cubic centimeter of air flow, and even more suitably at least about 2.5 million positive ions per cubic centimeter of air flow. In other embodiments, the positive ion density may be at least about 5 million positive ions per cubic centimeter of air flow, and may be as much as about 10 million positive ions per cubic centimeter of air flow. As used herein the ion density refers to a measurement taken by a suitable ion reading instrument at about 12 inches from the air outlet of the dryer and at a steady operating state of the dryer. As a dimensional example, the needle-shaped emitting member 107 of the illustrated embodiment has a length of about 12 mm. However, the length of the emitting member 107 may be less than or greater than 12 mm as long as the member terminates in a configuration sufficient to provide a corona effect (e.g., in the illustrated embodiment, a tip or point).

As seen best in FIG. 5, the positive ion emitting member 107 is suitably located in the barrel 29 intermediate the fan assembly 43 and the air outlet 39 so that positive ions emitted from the emitting member are released into air flowing from the fan 47 toward the air outlet. More suitably, the emitting member 107 is disposed toward the downstream end of the heating element 53 just upstream of the air outlet 39.

The negative ion emitter 103 is constructed separate from the positive ion emitter, that is, there is one emitter 101 for emitting positive ions and a separate emitter 103 for emitting negative ions, as opposed to a single emitter that simultaneously emits both positive and negative ions. In the illustrated embodiment, the negative ion emitter 103 is disposed entirely within the interior space 25 of the housing 23 and comprises a negative ion generator 109 and corresponding emitting member 111 electrically connected to the negative ion generator by suitable wiring (not shown). The negative ion generator 109 of the illustrated embodiment is suitably a high voltage generator formed separate from the positive ion generator 105 and disposed in the interior space 25 of the housing 23 generally within the handle 27, and more particularly toward the top of the handle adjacent the barrel 29.

The negative ion generator 109 is suitably configured for receiving current from the current source and generating a negative high voltage, such as in the range of about −5 kV to about −10 kV, and more suitably in the range of about −7 kV to about −9 kV. As one example, the negative ion generator 109 may be that available from Seawise Industrial Ltd. of Kowloon Hong Kong as model designation SW750H-9-3 or that available from Fu Fong Enterprises Co. as model designation FSI-120V-P3, with the ion generator being connected to the current source in reverse to thereby generate a negative high voltage instead of a positive high voltage. Alternatively, the negative ion generator 109 may be of a different construction than the positive ion generator 105 and may or may not have the same voltage generating capacity and/or ion producing capacity as the positive ion generator.

The negative ion emitting member 111 of the illustrated embodiment is suitably needle-shaped and is constructed of an electrically conductive metal, such as steel or other suitable metal. The emitting member 111 serves as an electrode for receiving the negative high voltage generated by the negative ion generator 109, thereby emitting negative ions into the interior space 25 of the housing 23, and more particularly within the barrel 29. More suitably, the negative ions are released into the flow path of air flowing within the barrel 29 toward the air outlet 39 so that the negative ions become entrained in the air flow exhausted from the air outlet. It is contemplated that more than one negative ion emitting member 111 may be used without departing from the scope of this invention.

In one embodiment, the air flow exiting the air outlet 39 during operation of the dryer to emit negative ions has a negative ion density of at least about 0.5 million negative ions per cubic centimeter of air flow, more suitably at least about 1 million negative ions per cubic centimeter of air flow, and even more suitably at least about 2.5 million negative ions per cubic centimeter of air flow. In other embodiments, the negative ion density may be at least about 5 million negative ions per cubic centimeter of air flow, and may be as much as about 10 million negative ions per cubic centimeter of air flow. In the illustrated embodiment the positive ion emitting member 107 and the negative ion emitting member 111 are of substantially the same construction and of the same shape and dimensions. However, the positive and negative ion emitting members 107, 111may be of different construction and/or they may have different shapes and/or dimensions without departing from the scope of this invention.

The negative ion emitting member 111 is suitably located in the barrel 29 intermediate the fan assembly 43 and the air outlet 39 so that negative ions emitted from the emitting member are released into air flowing from the fan 47 toward the air outlet. More suitably, the emitting member 111 is disposed toward the downstream end of the heating element 53 just upstream of the air outlet. It is understood, however, that the negative ion emitting member 111 may be disposed further upstream toward the fan assembly 43 without departing from the scope of this invention. In the illustrated embodiment, the positive and negative ion emitting members 107, 111 are located within the barrel 29 generally at the same longitudinal position. In one embodiment, the downstream ends, or tips of the ion emitting members 107, 111 are suitably located just upstream of the air outlet 39 (i.e., from the nearest portion of the air outlet), such as toward the downstream end of the heating element to reduce absorption of the generated ions by the heating element. For example, the tips of the ion emitting members 107, 111 may be less than or equal to about 25.4 mm upstream of the air outlet 39. It is understood, however, that the emitting members 107, 111 may be disposed further upstream toward the fan assembly 43 without departing from the scope of this invention.

The ion emitting members 107, 111 are also suitably spaced from each other, and from other electrically conductive components, a sufficient distance to inhibit arcing. For example, in the illustrated embodiment of FIG. 2, the ion emitting members 107, 111 may be spaced from each other a distance of at least about 16 mm and from other electrically conductive components a distance of at least about 9 mm. The positive and negative ion emitting members 107, 111 are also angularly spaced from each other within the barrel 29 approximately 180 degrees apart. However, the emitting members 107, 111 may be angularly spaced less than about 180 degrees apart, such as in the range of about 90 degrees to about 180 degrees, without departing from the scope of this invention, as long as they are otherwise sufficiently spaced from each other to inhibit arcing.

The positive and negative ion emitters 101, 103 are suitably operable to generate ions independent of the heating element 53 temperature. That is, either positive or negative ions may be emitted by the respective emitters 101, 103 regardless of the temperature of the heating element 53. In particular, the generation of positive and/or negative ions by the respective ion emitters 101, 103 and the ion density in the air flow exiting the air outlet 39 is generally unaffected by the temperature of the heating element. Accordingly, negative ions may be emitted into the air flow exhausted from the hair dryer whether no heat, low heat, medium heat or high heat is generated by the heating. The same is true for positive ions. For example, in the illustrated embodiment either positive ions or negative ions may be emitted by the ion emitters 101, 103 throughout the range of heating element 53 temperature, i.e., less than or equal to about 525 degrees Celsius, and more particularly in the range of about 200 to about 525 degrees Celsius. In other embodiments, positive and negative ions may be generated by the emitters 101, 103 when the heating element 53 temperature is less than or equal to about 400 degrees Celsius, and even less than or equal to about 300 degrees Celsius.

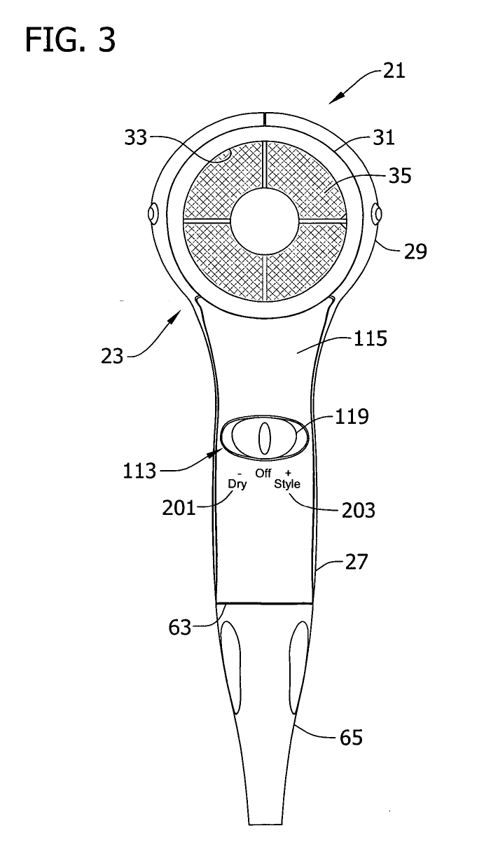

Referring to FIGS. 3 and 5, an ion switch assembly, generally indicated at 113, for controlling operation of the positive and negative ion emitters 101, 103 comprises a switch 117 disposed in the interior space 25 of the housing 23, and more particularly in the handle 27, and a switch cover 119 operatively connected to the switch and extending outward of what is referred to herein as a back 115 of the handle for accessibility in manually operating the switch assembly. It is understood, though, that the ion switch assembly 113 may be disposed on the front 75 of the handle 27 without departing from the scope of this invention.

The switch assembly 113 is operable for selective switching between positive ion production and negative ion production. In particular, the switch assembly of the illustrated embodiment is operable to switch the hair dryer between an ion inactive mode in which no current flows to the positive and negative ion generators 107, 111 (and thus no ions, positive or negative, are emitted into the air flow exhausted from the air outlet 39), a negative ion mode in which current flows to the negative ion generator 109 (but not to the positive ion generator 107) such that negative ions are emitted from the negative ion emitting member 111 into the air flow, and a positive ion mode in which current flows to the positive ion generator (but not to the negative ion generator) such that positive ions are emitted from the positive ion emitting member 107 into the air flow. Alternatively, the ion inactive mode may be omitted such that the switch assembly 113 is always in either the negative ion mode or the positive ion mode without departing from the scope of this invention.

FIG. 7 is a schematic wiring diagram of the hair dryer 21 illustrated in FIGS. 1-6. The hair dryer 21 receives current from the source 69 of current. The fan switch assembly 71 is represented by two gates 121, 123. Gate 121, corresponding to the low speed operating mode of the fan assembly 43, is electrically connected to the fan motor 45 with a rectifier 124 disposed along the circuit to reduce (e.g., by one-half) the power supplied to the fan motor. The other gate 123, corresponding to the high speed operating mode of the fan assembly, is electrically connected to the fan motor 45 (without reduced power) to operate the fan 47 at a higher speed. Thus, when the fan switch assembly is in its off mode, both gates 121, 123 are out of electrical connection with the source of current. In the low speed mode, gate 121 electrically connects the fan motor 45 to the current source 69. And in the high speed mode the other gate 123 electrically connects the fan motor 45 directly to the current source 69.

One wire 55 of the heating element 53 is electrically connected to the fan motor 45 such that current is conducted through the wire to generate heat anytime the fan assembly 43 is operated in either its low or high speed mode. This corresponds to the heating element switch assembly 73 being in its low heat mode. Gates 125 and 127 correspond respectively to the medium heat mode and the high heat mode of the heating element switch assembly 73. In both the low speed mode and the high speed mode of the fan switch assembly 71, gate 125 electrically connects the second heating element wire 57 to the current source 69 and gate 127 electrically connects the third heating element wire 59 to the current source. In the medium heat mode, gate 125 is closed such that both the first and second heating element wires 55, 57 generate heat and in the high heat mode gates125 and 127 are both closed so that all three heating element wires 55, 57, 59 generate heat. Gates 125 and 127, when closed, electrically connect the heating element wires 57, 59 to the current source 69 via the cool air switch assembly 85. Accordingly, when the cool air switch button 87 is depressed, current to the heating element wires 57, 59 is interrupted, thereby reducing the temperature of the air exhausted from the air outlet 39 until the button is released.

The ion switch assembly 113 is electrically connected to the current source 69 by closure of either gate 121 or gate 123 corresponding to the low and high speed modes of the fan assembly 43. That is, the positive and negative ion emitters 101, 103 are operable only when the fan assembly 43 is operating to generate an air flow that is exhausted from the air outlet 39. In the inactive mode of the ion switch assembly 113, the gate 129 is in position “0” in the diagram of FIG. 7 wherein the positive and negative ion generators 101, 103 are electrically disconnected from the current source 69. In the positive ion mode the gate 129 is in position “1” wherein current is conducted to the positive ion generator 105 to emit positive ions from the positive ion emitting member 107. And in the negative ion mode the gate 129 is in position “2” wherein current is conducted to the negative ion generator 109 to emit negative ions from the negative ion emitting member 111.

In operation of the hair dryer 21 according to one embodiment of a process of the present invention for drying hair, while the hair is wet the fan switch assembly 71 is switched to its low speed mode or high speed mode as desired such that the fan 47 rotation generates an air flow in which air is drawn into the barrel at the air inlet 33. Air flows downstream past the heating element 53 and ion emitting members 107, 111 and is exhausted from the air outlet 39 onto the wet hair. The heating element switch assembly 73 may be operated in any one of its low, medium and high heat modes depending on the desired air temperature of the air flow. While the wet hair is being dried by the heated air flow, the ion switch assembly 113 is suitably switched to its negative ion emitting mode to emit negative ions from the negative ion emitting member 111 in the barrel 39 for entrainment in the air flow exhausted from the air outlet and onto the hair. Alternatively, the heating element 53 can remain inactive while the hair is dried. Once the hair is relatively dry, the ion switch assembly 113 is suitably switched to its positive ion mode to emit positive ions from the positive ion emitting member 107 for entrainment in the air flow exhausted from the air outlet and onto the hair.

To this end, in one embodiment such as that illustrated in FIG. 3 a first indicia 201 may be located on the exterior of the handle adjacent the ion switch assembly to indicate a suggested use of the hair dryer in the negative ion mode, i.e., when the air exiting the air outlet contains negative ions. For example, the first indicia 201 shown in FIG. 3 is the word “dry” to suggest use of the hair dryer in the negative ion mode to dry the wet hair. Second indicia 203 on the handle adjacent the ion switch assembly indicates a suggested use of the hair dryer in the positive ion mode, i.e., when the air exiting the air outlet contains positive ions. As an example, the second indicia 203 shown in FIG. 3 is the word “style” to suggest use of the hair dryer in the positive ion mode to style the hair once it is substantially dry. It is understood that the first and second indicia may be words other than those shown in FIG. 3, or may be pictorial or graphic instead of alphanumeric, without departing from the scope of this invention.

When introducing elements of the present invention or preferred embodiments thereof, the articles “a”, “an”, “the”, and “said” are intended to mean that thee are one or more of the elements. The terms “comprising”, “including”, and “having” are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

1. A hair blower capable of selectively emitting positive and negative ions, said hair blower comprising:
a housing having an interior space, an air inlet through which air enters said interior space and an air outlet through which air is exhausted from said interior space;
a fan assembly in said interior space intermediate said air inlet and said air outlet operable to draw air into the interior space of the housing at the air inlet and to direct said air to flow through said interior space for exhaustion from the housing at the air outlet;
a positive ion emitter in said interior space of the housing, said positive ion emitter being operable to emit positive ions for entrainment in said air prior to exhaustion of said air from said housing;
a negative ion emitter in said interior space of the housing and separate from the positive ion emitter, said negative ion emitter being operable to emit negative ions for entrainment in said air prior to exhaustion of said air from said housing; and
a switch assembly for selectively operating the hair blower between a negative ion mode in which the negative ion emitter is operated to emit negative ions and the positive ion emitter is inoperable, and a positive ion mode in which the positive ion emitter is operated to emit positive ions and the negative ion emitter is inoperable.

2. The hair blower set forth in claim 1 wherein the positive ion emitter comprises a positive ion generator and a positive ion emitting member in electrical communication with the positive ion generator, the negative ion emitter comprising a negative ion generator separate from the positive ion generator and free from electrical communication therewith and a negative ion emitting member separate from the positive ion emitting member and in electrical communication with the negative ion generator.

3. The hair blower set forth in claim 2 wherein the positive ion emitting member and the negative ion emitting member are disposed in the interior space of the housing intermediate the fan assembly and the air outlet, said positive and negative ion emitting members being in spaced relationship with each other within the interior space of the housing.

4. The hair blower set forth in claim 3 wherein at least one of the positive and negative ion emitting members is spaced from the air outlet a distance of less than or equal to about 25.4 mm.

5. The hair blower set forth in claim 3 wherein the positive and negative ion emitting members are substantially equidistant from the air outlet.

6. The hair blower set forth in claim 2 wherein the positive ion emitting member is spaced from the negative ion emitting member within the housing a distance of at least about 16 mm.

7. The hair blower set forth in claim 2 wherein the positive ion emitting member is angularly spaced from the negative ion emitting member in the range of about 90 degrees to 180 degrees.

8. The hair blower set forth in claim 2 wherein the housing comprises a handle and a barrel, the air inlet and air outlet being disposed on the barrel of said housing, said fan assembly, said positive ion emitting member and said negative ion emitting member being disposed within the barrel of the housing, the positive ion generator and the negative ion generator being disposed generally within the handle of the housing.

9. The hair blower set forth in claim 1 wherein the switch assembly is further selectively operable in an inactive mode in which the positive ion emitter and the negative ion emitter are both inoperable.

10. The hair blower set forth in claim 1 further comprising a heating element in said interior space intermediate the fan unit and the air outlet.

11. A hair blower capable of selectively emitting positive and negative ions, said hair blower comprising:
a housing having an interior space, an air inlet through which air enters said interior space and an air outlet through which air is exhausted from said interior space;
a fan assembly in said interior space intermediate said air inlet and said air outlet operable to draw air into the interior space of the housing at the air inlet and to direct said air to flow through said interior space for exhaustion from the housing at the air outlet;
a heating element in said interior space intermediate said air inlet and said air outlet, said heating element being operable during operation of the hair blower to heat air within the interior space of the housing prior to the air being exhausted from the housing at said air outlet, said heating element having a heating element temperature during operation of the hair blower;
a positive ion emitter in said interior space of the housing, said positive ion emitter being operable to emit positive ions for entrainment in said air prior to exhaustion of said air from said housing, operation of the positive ion emitter to emit positive ions being independent of the heating element temperature;
a negative ion emitter in said interior space of the housing and separate from the positive ion emitter, said negative ion emitter being operable to emit negative ions for entrainment in said air prior to exhaustion of said air from said housing, operation of the negative ion emitter to emit negative ions being independent of the heating element temperature; and
an ion switch assembly for selectively operating the hair blower between a negative ion mode in which the negative ion emitter is operated to emit negative ions and the positive ion emitter is inoperable, and a positive ion mode in which the positive ion emitter is operated to emit positive ions and the negative ion emitter is inoperable.

12. The hair blower set forth in claim 11 wherein the positive and negative ion emitters are each capable of emitting positive and negative ions at a heating element temperature of less than or equal to about 525 degrees Celsius.

13. The hair blower set forth in claim 12 wherein the positive and negative ion emitters are each capable of emitting positive and negative ions at a heating element temperature of less than or equal to about 400 degrees Celsius.

14. The hair blower set forth in claim 13 wherein the positive and negative ion emitters are each capable of emitting positive and negative ions at a heating element temperature of less than or equal to about 300 degrees Celsius.

15. The hair blower set forth in claim 12 wherein in the positive ion mode the air exiting the air outlet has a positive ion density of at least about 0.5 million positive ions per cubic centimeter of air and in the negative ion mode the air exiting the air outlet has a negative ion density of at least about 0.5 million negative ions per cubic centimeter of air.

16. The hair blower set forth in claim 15 wherein in the positive ion mode the air exiting the air outlet has a positive ion density of at least about 2.5 million positive ions per cubic centimeter of air and in the negative ion mode the air exiting the air outlet has a negative ion density of at least about 2.5 million negative ions per cubic centimeter of air.

17. The hair blower set forth in claim 11 further comprising a heat switch assembly separate from the ion switch assembly for selectively controlling the heating element temperature.

18. A hair blower capable of selectively emitting positive and negative ions, said hair blower comprising:
a housing having an interior space, an air inlet through which air enters said interior space and an air outlet through which air is exhausted from said interior space;
a fan assembly in said interior space intermediate said air inlet and said air outlet operable to draw air into the interior space of the housing at the air inlet and to direct said air to flow through said interior space for exhaustion from the housing at the air outlet;
a heating element in said interior space intermediate said air inlet and said air outlet, said heating element being operable during operation of the hair blower to heat air within the interior space of the housing prior to the air being exhausted from the housing at said air outlet;
said hair blower being operable in a negative ion mode in which negative ions are emitted within the interior space of the housing for entrainment in the air prior to the air exiting from the housing at said air outlet and a positive ion mode in which positive ions are emitted within the interior space of the housing for entrainment in the air prior to the air exiting from the housing at said air outlet, said hair blower further comprising a switch assembly for selectively operating the hair blower between its negative ion mode and its positive ion mode;
first indicia on the housing associated with the switch assembly and indicative of a suggested use of the hair blower in the negative ion mode of operation; and
second indicia on the housing associated with the switch assembly and indicative of a suggested use of the hair blower in the positive ion mode of operation different from the suggested use of the hair blower in the negative ion mode of operation.

19. The hair blower set forth in claim 18 wherein the first indicia suggests use of the negative ion mode of operation for drying wet hair and the second indicia suggests use of the positive ion mode of operation for styling hair.

20. A process for blowing hair using a hair blower capable of generating an air flow within the hair blower for subsequent exhaustion therefrom for flow over the hair, said process comprising:
entraining negative ions in the air flow prior to said air flow being exhausted from the hair blower,
directing said negative ion air flow toward the hair while the hair is wet until the hair is substantially dried;
entraining positive ions in the air flow prior to said air flow being exhausted from the hair blower once the hair is substantially dried; and
directing said positive ion air flow toward the hair once the hair is substantially dried.
